(19) United States
(12) Patent Application Publication
(10) Pub. No.: US 2015/0302370 A1
(43) Pub. Date: Oct. 22, 2015

(54) SYSTEM AND METHOD FOR REAL TIME TRANSFERS BETWEEN ACCOUNTS

(71) Applicant: Capital One Financial Corporation, McLean, VA (US)

(72) Inventors: Luke A. HAMMOCK, Washington, DC (US); Lawrence DOUGLAS, McLean, VA (US)

(21) Appl. No.: 14/683,305

(22) Filed: Apr. 10, 2015

Related U.S. Application Data
(60) Provisional application No. 61/977,676, filed on Apr. 10, 2014.

(51) Int. Cl. G06Q 20/10; G06Q 20/40

(52) U.S. Cl. CPC G06Q 20/10; G06Q 20/40

(57) ABSTRACT

A system and method for real-time funds transfer that includes a financial institution server system that maintains an agent account for real-time transfers, an input/output module of the financial institution server system that receives a request for a real-time funds transfer, wherein the request for the real-time funds transfer includes destination account data, funds transfer amount, and source financial institution preference data, a destination agent module of the financial institution server system that processes the received request and determines whether the agent account can facilitate the real-time funds transfer based on the destination account data, funds transfer amount, and source financial preference data, and a destination account module of the financial institution server system that receives, in real-time from the agent account, the funds transfer amount if the destination agent module determines that the agent account can facilitate the real-time funds transfer.

### CROSS-REFERENCE TO RELATED APPLICATIONS

This application contains subject matter related to and claims the benefit of U.S. Provisional Patent Application No. 61/977,676, filed on Apr. 10, 2014, the entire contents of which is incorporated herein by reference.

### FIELD OF THE DISCLOSURE

The present disclosure relates to a system and method for real-time transfers between accounts held at financial institutions.

### BACKGROUND OF THE DISCLOSURE

Transferring funds between accounts held at separate financial institutions requires substantial information regarding the receiving financial institution and the receiving account. Such transfers also can require significant action on the recipient end (such as registration for receipt of funds).

In addition transferring funds between separate financial institutions requires time to perform the authorization, approval, and transfer process, often requiring at least a day in order to transfer funds from an account held at one financial institution to an account held at another financial institution. Accordingly, when an account holder having and account at one financial institution transfers funds to an account holder having an account at another financial institution, the actual transfer of funds into the destination account (where the funds are actually available for use) may require the use of a clearinghouse or other mechanism that necessitates at least a 24 hour period to perform the funds transfer. These and other drawbacks exist.

### SUMMARY OF THE DISCLOSURE

According to the various embodiments of the present disclosure, a system and method of real-time transfers between accounts held at financial institutions may include receiving a request from a source financial institution to transfer funds from a source account to a destination account at a destination financial institution, searching for at least one agent at the destination financial institution to execute an intra-institution transfer on behalf of the source financial institution, and executing, in real-time, the transfer of funds between the agent and the destination financial account.

### BRIEF DESCRIPTION OF THE DRAWINGS

Various embodiments of the present disclosure, together with further objects and advantages, may best be understood by reference to the following description taken in conjunction with the accompanying drawings, in the several Figures of which like reference numerals identify like elements, and in which:

FIG. 1 depicts an example embodiment of a system real-time transfers between accounts held at financial institutions according to an embodiment of the disclosure;

FIG. 2 depicts an example embodiment of a system for real-time transfers between accounts held at financial institutions according to an embodiment of the disclosure;

FIG. 3 depicts an example embodiment of system components real-time transfers between accounts held at financial institutions according to an embodiment of the disclosure; and

FIG. 4 depicts an example flow chart illustrating a method for real-time transfers between accounts held at financial institutions according to an embodiment of the disclosure.

### DETAILED DESCRIPTION OF THE EMBODIMENTS

The following description is intended to convey a thorough understanding of the embodiments described by providing a number of specific example embodiments and details involving systems and methods for real-time transfers between accounts held at financial institutions. It should be appreciated, however, that the present disclosure is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs. A source financial institution, source agent, source device, destination financial institution, destination agent, destination device, and/or merchant are used as examples for the disclosure. The disclosure is not intended to be limited to source financial institutions, source agents, source devices, destination financial institutions, destination agents, destination devices, and/or merchants only.

The example embodiments disclosed herein are directed to systems and methods for real-time transfers between accounts held at financial institutions, and the like. According to the various embodiments of the present disclosure, a financial institution and system supporting a financial institution are used as examples for the disclosure. The disclosure is not intended to be limited to financial institutions only and can be extended to any entity that provides consumers with a payment account, including e-commerce payment method linking to a particular payment account. Each financial system may house or maintain accounts holding account data, such as, for example, account holder name, account holder phone number, account holder address, account holder occupation and demographics, account number, account routing number, account balance, and/or account transaction information. Each financial institution system may include at least one agent operable to perform intra-institution transfers of funds from an agent account to a destination account housed at the financial institution at the direction of a source account housed at a source financial institution. An owner of the source account and/or destination account may be a consumer or a business. In this manner, transfers of funds involving a source account and a destination account may be consumer-to-consumer transfers, consumer-to-business transfers, business-to-consumer transfers, and/or business-to-business transfers. Real-time funds transfers may occur where the source financial institution and the destination financial institution are separate entities that are otherwise incapable of transferring funds in real-time without using the disclosed embodiments.

According to the various embodiments of the present disclosure, a system and method for real-time transfers between accounts held at financial institutions may further include funding an agent account in order to enable intra-institution transfers using an agent module. Agent account funding may be provided by a source bank or other party via an automatic clearing house transfer, wire transfer, or the like. Transfers may be scheduled transfers that occur daily, weekly, monthly, or any other predefined amount of time. Transfers also may occur upon detection of a transfer trigger, such as for example, or an agent account reaching a certain level, a calculation that a predicted transfer amount exceeds an agent account balance, and/or a detection of a requested transfer using the agent. An agent may be associated with an entity, such as, for example, the source financial institution, the destination financial institution, a third-party company, an individual representing the source financial institution, an individual representing the destination financial institution, and/or a third party individual representing a third-party company.

According to the various embodiments of the present disclosure, a system and method for real-time transfers between accounts held at financial institutions may further include utilizing multiple agents at a destination financial institution in order to facilitate a real-time funds transfer from a source financial institution account to a destination financial institution account. For example, where insufficient funds exist in an agent account and/or when agents are enabled to compete for real-time funds transfer facilitation, multiple agents may be used to execute the transfer and provide the funding for the transfer. Agents may be enabled to compete with one another in order to secure a benefit associated with facilitating the real-time funds transfer. For example, a benefit associated with facilitating a real-time funds transfer may include an interest fee provided by the source financial institution once funds from the source financial institution are moved to the agent account to replenish the amount transferred to the destination account, a fixed fee for facilitating the transfer, and/or a variable fee for facilitating the transfer. Variable fees may include a variable fee per transaction; a percentage of the transferred amount; and/or a tiered payment amount based on the number of transfers performed by an agent during a predetermined time period, the amount of funds transferred during a predetermined time period, the amount of funds borrowed during a predetermined time period, and/or some other scheme.

Competition for facilitating a real-time funds transfer may occur within a source financial institution system, a destination financial institution system, and/or a third-party system. For example, a third-party system may include various hardware and software modules to enable agents to register to bid and bid to transfer funds from an agent account held at a destination financial institution to a destination account held at a destination institution. Where the source financial institution does not maintain an agent account at a destination institution or does not have enough available funds in an agent account at a destination financial institution, the source financial institution may utilize this bidding functionality in order to provide the real-time funds transfer to a destination account held at a destination financial institution.

Bidding agents may provide agent information and bidding information in order to compete in fund transfer bidding. Agent information may include, for example, agent account identification data, agent account funding data, and/or agent identification data (e.g., agent name, agent address, agent phone number, agent email, agent website, agent representative name, agent representative phone number, agent representative email, and the like). Bidding information may include, for example, a transfer fee, a transfer interest rate, a transfer amount, and the like. According to one example, a bidding competition may determine one or more winning bidding agents based on the agent information and bidding information. For example, a bidding agent may win a bidding competition because the bidding agent bidding information indicated the lowest fee and/or interest rate associated with the highest amount of funding for the bid. Moreover, a bidding agent may win a bidding competition because the agent information contains agent identification data indicative of a preferred agent.

The bidding hardware and software modules also may be configured to perform a background check on bidding agents for fraud protection purposes, allow source financial institutions to set up agent relationships, such as a preferred agent relationship, and establish funding contracts, verify agent information, monitor suspicious activity reports related to potential anti-money laundering, notify agents of a winning big, facilitate or conduct a real-time funds transfer, and/or transmit notifications to a source financial institution and/or a source financial account holder regarding a complete real-time funds transfer. Verifying agent information may include, for example, a screen scraping of the agent's destination account data, using an application programming interface (“API”) from a destination financial institution to pull agent account information, using an agent's access code from a destination financial institution's open financial exchange feed, using an agent's credentials through an aggregator site (e.g., Yodlee), and/or any other method offered by a destination financial institution housing an agent account.

In performing a real-time funds transfer, a destination agent may include transfer information in the real-time funds transfer in addition to transferring the funds. Transfer information may include source financial institution identification information, source financial account identification information, transfer request date and/or timestamps, and/or transfer tracking and identification data. Once a real-time funds transfer is complete, the source financial institution, source financial account holder, destination financial institution, destination financial account holder, and/or agent(s) may be notified of the complete transfer. Notification may be conducted using any notification means, including, but not limited to, email, SMS message, MMS message, a push notification, a voice call, a voice message, or the like. Notifications to an account holder may include notifications to an account device, such as, for example, a computer and/or a mobile device. Confirmation of the completed transaction may be provided or collected by the source financial institution, destination, financial institution, and/or third party. For example, a source financial institution may pull or otherwise retrieve information about the destination financial account in order to confirm the transfer. In another example, the destination financial account may transmit a notification to the source financial institution using the transfer information. A notification may be send in a push notification, email, SMS message, MMS message, voice call, voice message, or any other form of notification.

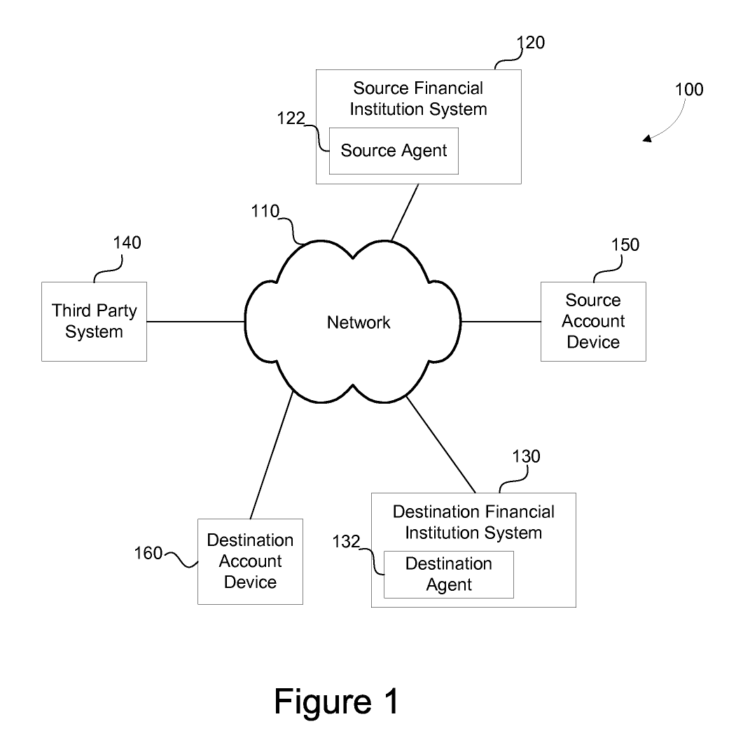

FIG. 1 depicts an example embodiment of a system 100 for real-time transfers between accounts held at financial institutions. The system 100 may include various systems connected to each other over a network 110. These systems include a source financial institution system 120, including a source agent 122, a destination financial institution system 130, including a destination agent 132, a third-party system 140, a source account device 150, and a destination account device 160.

The network 110 may be one or more of a wireless network, a wired network, or any combination of a wireless network and a wired network. For example, network 110 may include one or more of a fiber optics network, a passive optical network, a cable network, an Internet network, a satellite network, a wireless LAN, a Global System for Mobile Communication (GSM), a Personal Communication Service (PCS), a Personal Area Networks, (PAN), D-AMPS, Wi-Fi, Fixed Wireless Data, IEEE 802.11b, 802.15.1, 802.11n, and 802.11g or any other wired or wireless network for transmitting and receiving a data signal.

In addition, network 110 may include, without limitation, telephone lines, fiber optics, IEEE Ethernet 902.3, a wide area network (WAN), a local area network (LAN) or a global network such as the Internet. Also, network 110 may support an Internet network, a wireless communication network, a cellular network, or the like, or any combination thereof. Network 110 may further include one network, or any number of example types of networks mentioned above, operating as a stand-alone network or in cooperation with each other. Network 110 may utilize one or more protocols of one or more network elements to which they are communicatively couples. Network 110 may translate to or from other protocols to one or more protocols of network devices. Although network 110 is depicted as a single network, it should be appreciated that according to one or more embodiments, network 110 may comprise a plurality of interconnected networks, such as, for example, the Internet, a service provider's network, a cable television network, corporate networks, and home networks.

A source financial institution may access network 110 through one or more source financial institution systems 120 that may be communicatively coupled to the network 110. A destination financial institution may access the network 110 through one or more destination financial institution systems 130 that may be communicatively coupled to the network 110. One or more third-parties may access the network 110 through one or more third-party systems 140 that also may be communicatively coupled to the network 110. Additionally, one or more account holders may be communicatively coupled to the network 110 through a source account holder device 150 and/or destination account holder device 160. Although source financial institution system 120, source agent 122, destination financial institution system 130, destination agent 132, third-party system 140, source account device 150, and destination account device 160 are depicted as a single systems, devices, and/or agents, it should be appreciated that according to one or more embodiments, each system, device, and/or agent comprise a plurality of systems, devices, and/or agents.

An example source financial institution system 120, destination financial institution system 130, third-party system 140, source account device 150, and/or destination account device 160 may include one or more network-enabled computers to process instructions for methods of real-time funds transfer 400. As referred to herein, a network-enabled computer may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The one or more network-enabled computers of the example system 100 may execute one or more software applications for methods of fraud detection using social media data.

The source financial institution system 120, destination financial institution system 130, third-party system 140, source account device 150, and/or destination account device 160 may further include, for example, a processor, which may be several processors, a single processor, or a single device having multiple processors. The source financial institution system 120, destination financial institution system 130, third-party system 140, source account device 150, and/or destination account device 160 may access and be communicatively coupled to the network 110. The source financial institution system 120, destination financial institution system 130, third-party system 140, source account device 150, and/or destination account device 160 may store information in various electronic storage media, such as, for example, a database (not shown) and/or other data storage. Electronic information may be stored in the source financial institution system 120, destination financial institution system 130, third-party system 140, source account device 150, and/or destination account device 160 in a format such as, for example, a flat file, an indexed file, a hierarchical database, a post-relational database, a relational database, such as a database created and maintained with software from, for example Oracle® Corporation, Microsoft® Excel file, Microsoft® Access file, or any other storage mechanism.

The source financial institution system 120, destination financial institution system 130, third-party system 140, source account device 150, and/or destination account device 160 may send and receive data using one or more protocols. For example, data may be transmitted and received using Wireless Application Protocol (WAP), Multimedia Messaging Service (MMS), Enhanced Messaging Service (EMS), Short Message Service (SMS), Global System for Mobile Communications (GSM) based systems, Time Division Multiplexing (TDM) based systems, Code Division Multiples Access (CDMA) based systems suitable for transmitting and receiving data. Data may be transmitted and received wirelessly or may utilize cabled network connections or telecom connections, fiber connections, traditional phone wireline connection, a cable connection, or other wired network connection.

Each source financial institution system 120, destination financial institution system 130, third-party system 140, source account device 150, and/or destination account device 160 of FIG. 1 also may be equipped with physical media, such as, but not limited to, a compact disc (CD), a digital versatile disc (DVD), a floppy disk, a hard drive, read only memory (ROM), random access memory (RAM), as well as other physical media capable of storing software, or combinations thereof. Source financial institution system 120, including source agent 122, destination financial institution system 130, including destination agent, third-party system 140, source account device 150, and/or destination account device 160 may be able to perform the functions associated with methods of real-time funds transfers. Source financial institution system 120, destination financial institution system 130, third-party system 140, source account device 150, and/or destination account device 160 may, for example, house the software for methods of real-time funds transfers, obviating the need for a separate device on the network 110 to run the methods housed on source financial institution system 120, destination financial institution system 130, third-party system 140, source account device 150, and/or destination account device 160.

Furthermore, the information stored in a database (not shown) may be available over the network 110, with the network containing data storage. A database maintained on source financial institution system 120, destination financial institution system 130, third-party system 140, source account device 150, and/or destination account device 160 or the network 110, may store, or may connect to external data warehouses that stores, account holder data, social media subscriber data, third party account data, deals and/or rewards data, and/or transaction data.

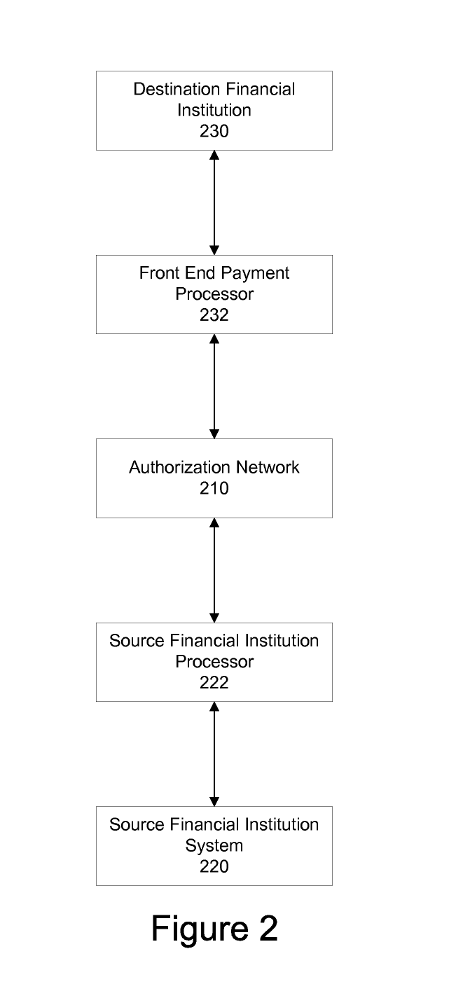

As illustrated in FIG. 2 for example, network 210, which may be similar to network 110, may include an authorization network 210 to allow source financial institution 220 transfer funds to a destination financial institution 230. Such a funds transfer may be necessary in order to replenish and/or fund an agent account housed at a destination financial institution 230 that is used in the real-time funds transfer methods. An authorization network 210 may be used to communicate payment requests from a destination financial institution 230 to a source financial institution 220 as well as payment determinations from the source financial institution 220 to the destination financial institution 230. In communicated payment requests, a destination financial institution 230 may transmit and/or pass funds transfer information, which includes payment and/or reimbursement information, to a front-end payment processor 232 that maintains connections with a variety of networks 210 connected to source financial institution 220. The front-end payment processor may transmit and/or pass along the transaction and/or reimbursement information to the appropriate network 210, which may then transmit and/or route the transaction and/or reimbursement information to the source financial institution processor (or a back-end payment processor) 222. The source financial institution processor 222 may review or check the transaction and/or reimbursement details in order to approve (or deny) a funds transfer request. This may include a fraud detection algorithm to ensure that the transfer and/or reimbursement request is authentic and valid. The source financial institution 220 may concurrently verify a payment for the received transaction and/or reimbursement information. The verification of a funds transfer payment (or denial of payment) may then be sent from the source financial institution system 220 via the source financial institution processor 222 through the authorization network 210 and front-end processor 232 to the destination financial institution system 230.

The authorization system illustrated in FIG. 2 may be used to both perform real-time authorization as well as batch funds transfer payment processing. In a batch payment processing system, the source financial institution system 220 may perform a funds transfer payment authorization in real-time and then subsequently process the funds transfer payment at the source financial institution system 220 in batch processing.

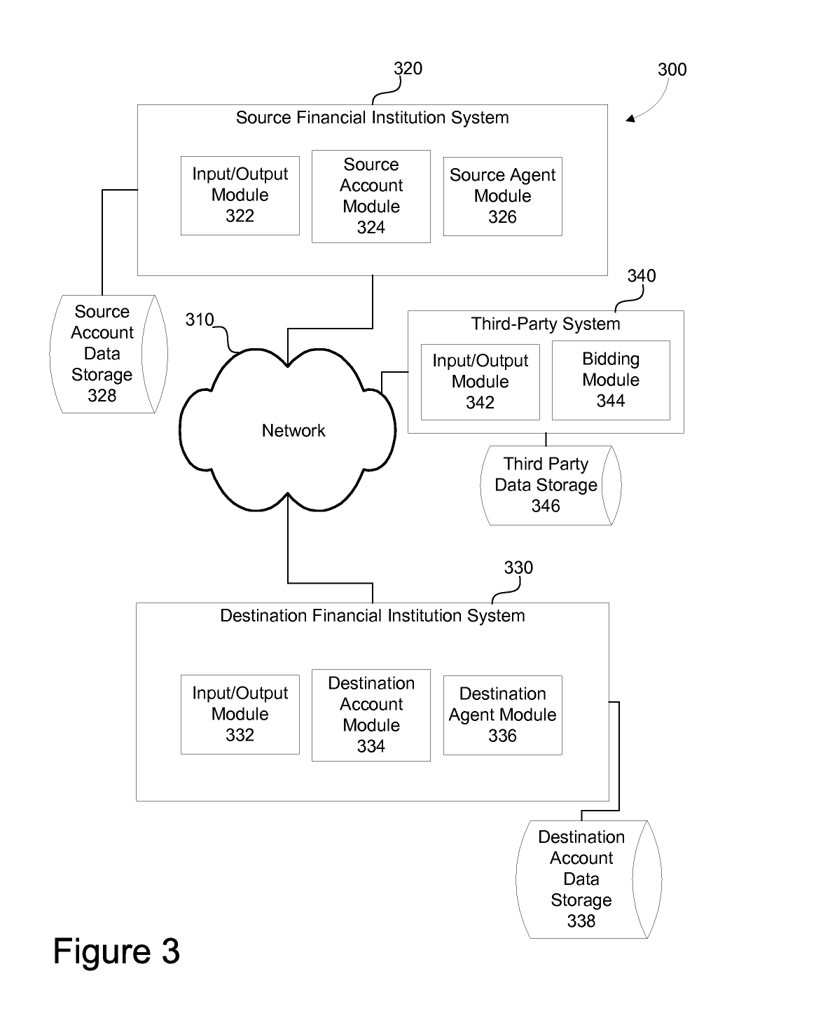

FIG. 3 illustrates various modules used in, for example, source financial institution system 320, which may be similar to source financial institution system 120, destination financial institution system 330, which may be similar to account provider system 130, and third-party system 340, which may be similar to third-party system 140. As used herein, the term “module” may be understood to refer to computer executable software, firmware, hardware, and/or various combinations thereof. It is noted that the modules are exemplary. The modules may be combined, integrated, separated, or duplicated to support various applications. Also, a function described herein as being performed at a particular module may be performed at one or more other modules and by one or more other devices instead of or in addition to the function performed at the particular module. Further, the modules may be implemented across multiple devices or other components local or remote to one another. Additionally, the modules may be moved from one device and added to another device, or may be included in both devices.

Source financial institution system 320 may include an input/output module 322 and a source account module 324, and source agent module 326. The input/output module 322 may include various hardware and software components, such as, for example, a repeater, a microwave antenna, a cellular tower, or another network access device capable of providing connectivity between network mediums. The input/output module 322 may be capable of sending or receiving signals via network 310. Moreover, the input/output module 322 may provide connectivity to one or more wired networks and may be capable of receiving signals on one medium such as a wired network and transmitting the received signals on a second medium such as a wireless network.

Source account module 324 may include various hardware and software components, such as for example, data storage and at least one processor, capable of providing source account information. Source account module 324 also may provide functionality associated with transferring funds from a source account to an agent housed at a destination financial institution system 330. For example, source account module 324 may provide the functionality described with respect to the source financial institution processor 222 illustrated in FIG. 2. In this manner, when a source financial institution account holder desires to provide a real-time funds transfer to a destination financial account, the source account module 324 may be configured to perform a funds transfer to replenish and/or fund a destination agent at a destination financial institution system 336. Funds may first be transferred from a source account to a source agent so that the source agent account performs the real-time funds transfer between a source financial institution 320 and a destination financial institution 330. According, source agent module 326 may include various hardware and software components, such as for example, data storage and at least one processor, capable of performing a real-time funds transfer.

Source financial institution system 320 may also include a source account data storage 328 capable of storing source financial institution account information. Source financial account information may include, for example, account holder name, account holder phone number, account holder address, account holder occupation and demographics, account number, account routing number, account balance, and/or account transaction information. Source financial account information may also include source agent account information. Source agent account information may include, for example, agent account identification data, agent account funding data (e.g., agent account balance, agent account transaction data, and the like), and/or agent identification data (e.g., agent name, agent address, agent phone number, agent email, agent website, agent representative name, agent representative phone number, agent representative email, and the like).

Destination system 330 may include an input/output module 332, a destination account module 334, and a destination agent module 336. The input/output module 332 may include various hardware and software components, such as, for example, a repeater, a microwave antenna, a cellular tower, or another network access device capable of providing connectivity between network mediums. The input/output module 332 may be capable of sending or receiving signals via network 310. Moreover, the input/output module 332 may provide connectivity to one or more wired networks and may be capable of receiving signals on one medium such as a wired network and transmitting the received signals on a second medium such as a wireless network.

Destination account module 334 may include various hardware and software components, such as data storage and at least one processor, to perform a real-time funds transfer receipt. Destination account module 334 may access a destination account housed at a destination financial institution system, receive a real-time electronic transfer of funds, and provide confirmation regarding the transfer of funds. Destination account module 334 may utilize a destination API in order to provide confirmation regarding the transfer of funds to, for example, a source financial institution 320.

Destination agent module 336 may include various hardware and software components, such as data storage and at least one processor, to facilitate real-time funds transfers. For example, destination agent module may determine a destination agent capable of performing a real-time funds transfer to a destination account housed at destination financial institution 330. In order to be capable of performing a real-time funds transfer and destination agent account must satisfy approval, authorization, and transfer requirements. Approval requirements may include, for example, fraud detection requirements to ensure that the destination agent is not fraudulent or under suspicion of, for example, potential money laundering. Authorization requirements may include, for example, authorization that the destination agent account maintains a balance capable of providing the real-time transfer. Transfer requirements may include, for example, other requirements associated with the real-time funds transfer, such as a preferred destination agent requirement, a fee and/or interest rate requirement, and/or other term requirements associated with a real-time funds transfer. Destination agent module 336 may also perform the functionality described below with reference to bidding module 344.

Destination financial institution system 330 may also include destination account data storage 338 capable of storing destination financial institution account information. Destination financial account information may include, for example, account holder name, account holder phone number, account holder address, account holder occupation and demographics, account number, account routing number, account balance, and/or account transaction information. Destination financial account information may also include destination agent account information. Destination agent account information may include, for example, agent account identification data, agent account funding data (e.g., agent account balance, agent account transaction data, and the like), and/or agent identification data (e.g., agent name, agent address, agent phone number, agent email, agent website, agent representative name, agent representative phone number, agent representative email, and the like).

Third-party system 340 may include an input/output module 342 and a bidding module 344. The input/output module 342 may include various hardware and software components, such as, for example, a repeater, a microwave antenna, a cellular tower, or another network access device capable of providing connectivity between network mediums. The input/output module 342 may be capable of sending or receiving signals via network 310. Moreover, the input/output module 342 may provide connectivity to one or more wired networks and may be capable of receiving signals on one medium such as a wired network and transmitting the received signals on a second medium such as a wireless network.

Bidding module 344 may include various software and hardware components, such as data storage and at least one processor, capable of performing real-time funds transfer bidding. For example, bidding module 344 may include various hardware and software modules to enable agents to register to bid and bid to transfer funds from a destination agent account held at a destination financial institution 330 to a destination account held at a destination institution 330. Where the source financial institution does not maintain an agent account at a destination institution or does not have enough available funds in an agent account at a destination financial institution, the source financial institution may connect to third-party system 340 and utilize bidding functionality of bidding module 344 in order to provide the real-time funds transfer to a destination account held at a destination financial institution.

Bidding module 344 may be capable of receiving agent information and bidding information for agents participating in a real-time funds transfer bidding process. Bidding module 344 may receive agent information from third party data storage 346, which may house agent information. Agent information may include, for example, agent account identification data (e.g., account number, routing number, and the like), agent account funding data (e.g., agent account balance, agent account transaction data, and the like), and/or agent identification data (e.g., agent name, agent address, agent phone number, agent email, agent website, agent representative name, agent representative phone number, agent representative email, and the like). Bidding information may include, for example, a transfer fee, a transfer interest rate, a transfer amount, and the like. According to one example, a bidding module 344 may determine one or more winning bidding agents based on the agent information and bidding information. For example, bidding module 344 may determine a winning bidding agent because the bidding agent bidding information indicated the lowest fee and/or interest rate associated with the highest amount of funding for the bid. Moreover, bidding module 344 may determine a winning bidding agent because the agent information contains agent identification data indicative of a preferred agent.

Bidding module 344 also may be configured to perform a background check on bidding agents for fraud protection purposes, allow source financial institutions to set up agent relationships, such as a preferred agent relationship, and establish funding contracts, verify agent information, monitor suspicious activity reports related to potential anti-money laundering, notify agents of a winning big, facilitate or conduct a real-time funds transfer, and/or transmit notifications to a source financial institution and/or a source financial account holder regarding a complete real-time funds transfer. Verifying agent information may include, for example, a screen scraping of the agent's destination account data, using an API from a destination financial institution system 330 to pull agent account information, using an agent's access code from a destination financial institution's open financial exchange feed, using an agent's credentials through an aggregator site (e.g., Yodlee), and/or any other method offered by a destination financial institution housing an agent account.

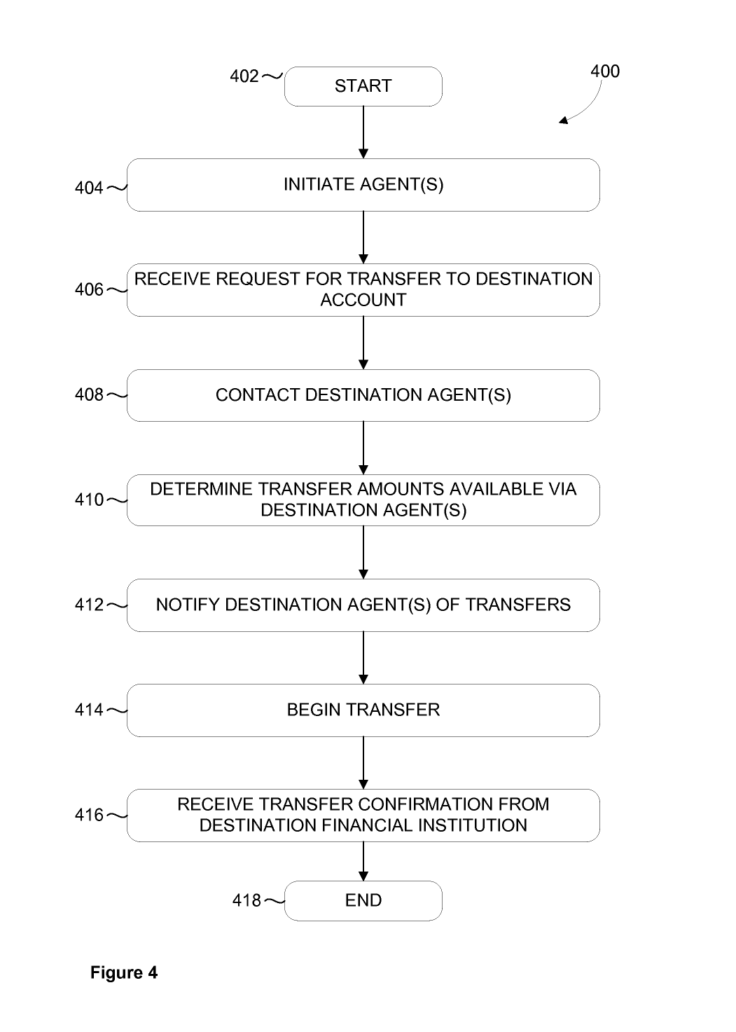

FIG. 4 illustrates a method for real-time funds transfers 400. The method 400 may begin at block 402. At block 404, agents may be initiated at a source financial institution and/or a destination financial institution. Initiation of agents may involve opening an agent account, activating an agent account, and/or funding an agent account. Initiating agents may include establishing agent accounts at a source financial institution and/or a destination financial institution. An owner of the source account and/or destination account may be a consumer or a business. In this manner, transfers of funds involving a source account and a destination account may be consumer-to-consumer transfers, consumer-to-business transfers, business-to-consumer transfers, and/or business-to-business transfers. An agent account may be required at a destination financial institution system to perform a real-time funds transfer. In this manner, a source financial institution may utilize a destination agent account in order to perform an intra-bank transfer of funds from the destination agent account to the destination account. Initiating agents may further include performing any background and/or fraud checks on the agents, collecting information required to complete a real-time funds transfer process, such as agent account information, and establishing any fees and/or interest rates that may be associated with the agent accounts. For example, fees and/or interest rates associated with agent accounts may include an interest fee associated with replenishing or funding an amount transferred to the destination account, a fixed fee for facilitating the transfer, and/or a variable fee for facilitating the transfer. Variable fees may include a variable fee per transaction; a percentage of the transferred amount; and/or a tiered payment amount based on the number of transfers performed by an agent during a predetermined time period, the amount of funds transferred during a predetermined time period, the amount of funds borrowed during a predetermined time period, and/or some other scheme. Where the real-time funds transfer method 400 includes utilizing a third-party system for transfer bidding, initiating the agents 404 may include transmitting agent information to the third-party system for storage.

At block 406, once all agents have been initiated, a request for a real-time funds transfer may be received. A request for a real-time funds transfer may include a request from a source financial institution account to transfer fund from the source account to a destination account held at a destination financial institution. The request may include transfer data indicative of the destination account to receive the transfer. Transfer data may include, for example, a phone number, an email address, a destination account holder name, a destination account holder number, a destination account routing number, or any other data that identifies the destination account.

At block 408, a source financial institution housing or maintaining the source financial account may transmit a notification to at least one destination agent notifying the destination agent(s) of the transfer. Where a source financial institution maintains an agent account at a destination financial institution, the source financial institution may notify that agent account. Where a source financial institution does not maintain an agent account at a destination financial institution, the source financial institution may transmit a preferred agent list to a destination financial institution and/or a third-party system. The destination financial institution may search agent accounts for at least one preferred agent and transmit a notification to the at least one preferred agent. The notifications may include transfer information, such as a requested transfer amount. Accordingly, at block 410, the destination financial institution and/or third-party system may ensure that the destination agent account(s) are capable of providing the real-time funds transfer. The notification may also include whether the source financial institution authorizes utilizing multiple agents at a destination financial institution in order to facilitate a real-time funds transfer from a source financial institution account to a destination financial institution account. For example, where insufficient funds exist in an agent account and/or when agents are enabled to compete for real-time funds transfer facilitation, multiple agents may be used to execute the transfer and provide the funding for the transfer.

Where a source financial institution requests a bidding for a destination agent account, the destination financial institution and/or third-party system may institute a bidding for at least one destination agent account to facilitate the real-time funds transfer using a bidding module. Agents may be enabled to compete with one another in order to secure a benefit associated with facilitating the real-time funds transfer. For example, a benefit associated with facilitating a real-time funds transfer may include an interest fee provided by the source financial institution once funds from the source financial institution are moved to the agent account to replenish the amount transferred to the destination account, a fixed fee for facilitating the transfer, and/or a variable fee for facilitating the transfer. Variable fees may include a variable fee per transaction; a percentage of the transferred amount; and/or a tiered payment amount based on the number of transfers performed by an agent during a predetermined time period, the amount of funds transferred during a predetermined time period, the amount of funds borrowed during a predetermined time period, and/or some other scheme.

Bidding modules used in blocks 408-410 may enable agents to register to bid and bid to transfer funds from an agent account held at a destination financial institution to a destination account held at a destination institution. Bidding agents may provide agent information and bidding information to the bidding module in order to compete in fund transfer bidding. Agent information may include, for example, agent account identification data, agent account funding data, and/or agent identification data (e.g., agent name, agent address, agent phone number, agent email, agent website, agent representative name, agent representative phone number, agent representative email, and the like). Bidding information may include, for example, a transfer fee, a transfer interest rate, a transfer amount, and the like. According to one example, a bidding competition may determine one or more winning bidding agents based on the agent information and bidding information. For example, a bidding agent may win a bidding competition because the bidding agent bidding information indicated the lowest fee and/or interest rate associated with the highest amount of funding for the bid. Moreover, a bidding agent may win a bidding competition because the agent information contains agent identification data indicative of a preferred agent.

Bidding modules also may be configured to perform a background check on bidding agents for fraud protection purposes, allow source financial institutions to set up agent relationships, such as a preferred agent relationship, and establish funding contracts, verify agent information, monitor suspicious activity reports related to potential anti-money laundering, notify agents of a winning big, facilitate or conduct a real-time funds transfer, and/or transmit notifications to a source financial institution and/or a source financial account holder regarding a complete real-time funds transfer. Verifying agent information may include, for example, a screen scraping of the agent's destination account data, using an API from a destination financial institution to pull agent account information, using an agent's access code from a destination financial institution's open financial exchange feed, using an agent's credentials through an aggregator site (e.g., Yodlee), and/or any other method offered by a destination financial institution housing an agent account.

Once the one or more destination agent accounts are determined, either via a bidding or via a request from a source financial institution, the destination agent accounts and account holders may be notified of the transfer (block 412). Notification may be conducted using any notification means, including, but not limited to, email, SMS message, MMS message, a push notification, a voice call, a voice message, or the like. Notifying the agent account initiates the transfer of funds from the agent account to the destination account. Notifying the destination agent account holder may include notifying the agent account holder of the transfer amount, updated agent account balance, and/or time and date of the transfer.

At block 414, the transfer between the agent account at the destination financial institution and the destination account at the destination financial institution may begin. In performing a real-time funds transfer, a destination agent may include transfer information in the real-time funds transfer in addition to transferring the funds. Transfer information may include source financial institution identification information, source financial account identification information, transfer request date and/or timestamps, and/or transfer tracking and identification data. Once a real-time funds transfer is complete, the source financial institution, source financial account holder, destination financial institution, destination financial account holder, and/or agent(s) may be notified of the complete transfer (block 416). Notification may be conducted using any notification means, including, but not limited to, email, SMS message, MMS message, a push notification, a voice call, a voice message, or the like. Notifications to an account holder may include notifications to an account device, such as, for example, a computer and/or a mobile device. Confirmation of the completed transaction may be provided or collected by the source financial institution, destination, financial institution, and/or third party. For example, a source financial institution may pull information about the destination financial account in order to confirm the transfer. In another example, the destination financial account may transmit a notification to the source financial institution using the transfer information. A notification may be send in a push notification, email, SMS message, MMS message, voice call, voice message, or any other form of notification. In addition to notification, the receipt of transfer confirmation from the destination financial institution may trigger a transfer from the source financial institution to the agent housed at the destination financial institution in order to replenish and/or fund the agent that facilitated the real-time funds transfer. Agent account funding may be provided by a source bank via an automatic clearing house transfer, wire transfer, or the like. Transfers may be scheduled transfers that occur daily, weekly, monthly, or any other predefined amount of time. Transfers also may occur upon detection of a transfer trigger, such as for example, or an agent account reaching a certain level, a calculation that a predicted transfer amount exceeds an agent account balance, and/or a detection of a requested transfer using the agent. An agent may be associated with an entity, such as, for example, the source financial institution, the destination financial institution, a third-party company, an individual representing the source financial institution, an individual representing the destination financial institution, and/or a third party individual representing a third-party company. At block 418, the method may end.

It should be appreciated that the foregoing discussion related to FIGS. 1 through 4 is illustrative only, and that the various embodiments of the disclosure may be implemented by any other appropriate system or method.

In the preceding specification, various preferred embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

We claim:

1. A system, comprising:
a financial institution server system that maintains an agent account for real-time transfers;
an input/output module of the financial institution server system that receives a request for a real-time funds transfer, wherein the request for the real-time funds transfer includes destination account data, funds transfer amount, and source financial institution preference data;
a destination agent module of the financial institution server system that processes the received request and determines whether the agent account can facilitate the real-time funds transfer based on the destination account data, funds transfer amount, and source financial preference data; and
a destination account module of the financial institution server system that receives, in real-time from the agent account, the funds transfer amount if the destination agent module determines that the agent account can facilitate the real-time funds transfer.

2. The system of claim 1, wherein the agent account is associated with two or more bidder account modules that submit respective bids to fund the agent account with funds for the real-time funds transfer.

3. The system of claim 2, wherein the bidder account modules submit respective bids before the request is received.

4. The system of claim 2, wherein the bidder account modules submit respective bids if the destination agent module determines that the agent account cannot facilitate the real-time funds transfer.

5. The system of claim 1, further comprising an enrollment module associated with the financial institution server system that enrolls the agent account.

6. The system of claim 5, wherein the enrollment module includes an application programming interface that interacts with another financial institution to retrieve, via a network, account information that is used to enroll the agent account.

7. The system of claim 5, wherein the enrollment module an application programming interface that interacts with a third party to perform a background check on an agent associated with the agent account.

8. The system of claim 1, wherein the input/output module transmits a notification an agent of the agent account of the real-time transfer.

9. A method, comprising:
maintaining, in data storage at a financial institution server system, an agent account for real-time transfers;
receiving, via a network at an input/output module of the financial institution server system, a request for a real-time funds transfer, wherein the request for the real-time funds transfer includes destination account data, funds transfer amount, and source financial institution preference data;
processing, using a processor associated with a destination agent module of the financial institution server system, the received request;
determining, using the processor associated with the destination agent module of the financial institution server system, whether the agent account can facilitate the real-time funds transfer based on the destination account data, funds transfer amount, and source financial preference data; and
receiving, at a destination account module of the financial institution server system in real-time from the agent account, the funds transfer amount if the destination agent module determines that the agent account can facilitate the real-time funds transfer.

10. The method of claim 9, wherein the agent account is associated with two or more bidder account modules that submit respective bids to fund the agent account with funds for the real-time funds transfer.

11. The method of claim 10, wherein the bidder account modules submit respective bids before the request is received.

12. The method of claim 10, wherein the bidder account modules submit respective bids if the destination agent module determines that the agent account cannot facilitate the real-time funds transfer.

13. The method of claim 9, further comprising enrolling the agent account using an enrollment module associated with the financial institution server system.

14. The method of claim 13, wherein the enrollment module includes an application programming interface that interacts with another financial institution to retrieve, via a network, account information that is used to enroll the agent account.

15. The method of claim 13, wherein the enrollment module an application programming interface that interacts with a third party to perform a background check on an agent associated with the agent account.

16. The method of claim 9, further comprising, transmitting, via the network using the input/output module, a notification to an agent of the agent account of the real-time transfer.
